(19) United States
(12) Patent Application Publication
(10) Pub. No.: US 2014/0040602 A1
(43) Pub. Date: Feb. 6, 2014

(54) Storage Method, Memory, and Storing System with Accumulated Write Feature

(71) Applicant: Hoffmann Jochen, Xi'an (CN)

(72) Inventor: Hoffmann Jochen, Xi'an (CN)

(73) Assignee: Xi'an Sinochip Semiconductors Co., Ltd., Xi'an, Shaanxi (CN)

(21) Appl. No.: 14/003,808

(22) PCT Filed: Dec. 30, 2011
(86) PCT No.: PCT/CN11/85007

§ 371 Date: Sep. 8, 2013

(30) Foreign Application Priority Data
Mar. 31, 2011 (CN) 201110079022.8

(51) Int. Cl. G06F 9/30

(52) U.S. Cl. CPC G06F 9/30145; G06F 9/3001
USPC 712/208

(57) ABSTRACT

A storage method, a memory and a storage system that have an accumulated write feature are provided in which the OR and AND operation are shifted from CPU/ALU (controller) to the memory, and the frequency for switching data transmission lines between read and write instructions can be reduced. In the memory, the interface unit includes a write arithmetic instruction interface, a write instruction interface, and an address instruction interface; the instruction/address decoder is configured to decode a write arithmetic instruction, a write instruction and an address instruction; and the pFET has a higher driving capability than the data switches, and the nFET has a lower driving capability than the data switches. The storage method, memory and storage system can reduce work load of CPU/ALU, and enable continuous data writing to the memory.

### CROSS-REFERENCE TO RELATED APPLICATIONS

The present application is the national stage application under 35 USC §371 of the PCT application, serial no. PCT/CN2011/085007, filed on Dec. 30, 2011. The PCT international application further claims the priority of a Chinese patent application, serial no. 201110079022.8, filed on Mar. 31, 2011. The entire contents of the priority documents are hereby incorporated by reference.

### TECHNICAL FIELD

The present invention relates to a data storage method in an electronic device, and a memory and a storage system thereof.

### BACKGROUND

Different types of memories, such as dynamic random access memory (DRAM), static random access memory (SRAM), and Flash, have been used in almost all modern electronic devices (e.g., computer, mobile phone, router, set-top box, printer, Global Positioning System (GPS)). These memories can be used to store and retrieve binary data which are processed by a different part of the system (e.g., Central Processing Unit (CPU)).

For a write operation of a memory, the memory may give an address and a write instruction, and give data upon or after giving the write instruction. The data may be subsequently written to a memory cell of the selected address (depending on the type of the used storage device, data may be transmitted at each single period via a single pin or multiple parallel pins, or data may be transmitted in a burst over multiple periods).

Data previously stored at the same address may be overwritten unconditionally according to the write instruction.

For a read operation of the memory, an address and a read instruction may be provided to the memory. After a certain delay (i.e., time required for retrieving data), the memory may output data (transmitting data at each period or in a burst over multiple periods), and a controller or CPU may latch or process the data.

The memory usually functions as a servant device in the system. That is, the memory executes a given instruction (address and instruction are both unidirectional, i.e., from the controller/CPU to the memory). On the contrary, a data transmission line is bidirectional, i.e., the memory can receive data (at a write operation) and transmit data (at a read operation).

Data throughput realized with a single memory/multiple memories is a key factor for maximizing the overall speed of a system. Data can flow unidirectionally from the controller to the memory only after a write instruction is executed. The First-in First-out (FIFO) act within the controller can reduce the delay/latency between address/instruction and data. In this way, it is possible to continuously output data over the data transmission line (and thus the maximal data rate may be reached).

The above principle is also applicable to a sequence containing only read instructions. Data flow unidirectionally from the controller/CPU to the memory. It is possible to reach the maximal data rate with a continuous use of the data transmission line (transmitting a continuous sequence of addresses/instructions, and thus continuously outputting data).

There will be a considerable decrease in the data rate, if the instruction sequence includes alternately read and write instructions. The reason for such phenomenon is that for each switching from a read instruction to a write instruction, the bidirectional data transmission line has to change its transmission direction, and vice versa. As an example, the controller issues a read instruction. Data appear at the data pin of the memory after a certain delay (i.e., read delay). The data are transmitted to the controller via the data transmission line and received by the controller. At this time, if the next instruction is a write instruction, the controller can transmit data to the memory only after the controller safely receives and stores the data previously sent from the memory. Otherwise, data conflict may occur, and the previously-sent data may be lost. Once the controller allows data transmission, the data will be transmitted from the controller to the memory via the data transmission line, received by the memory, and transferred and stored in the selected cell of the memory. The next read instruction can be executed only after the foregoing operation is completed.

It is thus desirable to enable a long-term unidirectional transmission on the data transmission line, instead of any switching from read to write (or vice versa) of the data transmission line between the controller/CPU and the memory, thereby reducing the occurrence frequency for such switching of the data transmission line. Unfortunately, the defined operations/algorithms have to utilize a large amount of data (e.g., pattern recognition algorithm, neural network, plotting error, and the like).

For example, an operation X:=X|Y; (fetch data X; perform OR operation on data Y and X; and store new data X) requires one CPU and one memory in the system, and is executed through the following sequence:

a) CPU issues a read instruction to the memory to retrieve data X;
b) CPU waits so that the read instruction is sent to the memory, and the memory decodes and executes the instruction, and then output data to the data transmission line (i.e., read delay);
c) CPU retrieves data X;
d) the Arithmetic Logical Unit (ALU) within CPU performs an operation X|Y (assuming that data Y is stored in a register);
e) CPU issues a write instruction to write the operation result (X:=X|Y) in the memory;
f) depending on the type of the memory (e.g., DDR2, or DDR3 DRAM), CPU waits until the write instruction has been sent, and then transmits data;
g) the memory receives the data transmitted via the data transmission line from CPU to the memory, and the data are transferred inside the memory to a corresponding memory cell and stored therein.

After all the above steps are completed, the memory can then read next piece of data.

According to the minimal specified timing when multiple read and write instructions are executed in the standard of DDR3 DRAM, the following will be seen:

a) read operations are performed in a continuous form of read-to-read operations and continuous data output (the data transmission line can be 100% used);
b) write-to-write operations can also enable 100% use of the data transmission line;
c) a small interval is required for switching from read to write, and is 2 clock cycles (4 cycles of data, 2 cycles of the interval, and thus the utilization of the data transmission line is 66%);
d) the worst case for DRAM is switching from write to read, that is, next read can be executed only after data in all memory cells have been read; 13 cycles are required between issuance of a write instruction and issuance of a read instruction (4 cycles of data, 9 cycles of interval, and thus the utilization of the data transmission line is 31%).

So far, a method for solving the above problems is reducing the switching frequency by read/write larger blocks of data at any time. Another method is adding one or more intermediate cache memories of different levels. The cache memory is a high-speed memory that can read/write larger data blocks from a low-speed memory to a cache line or area. This can reduce the total number of times the low-speed memory is accessed, and also can improve data access efficiency with transmission of data blocks.

Although the faster cache memory can shorten the delay period, the above method cannot solve each of the foregoing problems when data for OR or AND operation are stored in the cache memory.

### SUMMARY

An object of the present invention is to provide a storage method, a memory and a storage system that have an accumulated write feature. With the present invention, the OR operation and the AND operation are shifted from CPU/ALU (controller) to the memory, and the frequency for switching data transmission lines between read and write instructions can be reduced.

A solution of the present invention is a storage method with an accumulated write feature, comprising:

1) providing a standard instruction interface between a controller or CPU and a memory, so that the controller or CPU can send a write instruction, an address instruction and a write arithmetic instruction to the memory, wherein the write arithmetic instruction comprises a “write_OR” instruction and/or a “write_AND” instruction;
2) decoding the write instruction, the address instruction and the write arithmetic instruction by an instruction/address decoder in the memory;
3) if a “write_OR” instruction is decoded, turning on a “write_OR” data switch of complementary data switches in a memory cell corresponding to the address instruction, wherein data written from a data transmission line can switch non-inverted data in cross-coupled inverters from 0 to 1, but not from 1 to 0; if a “write_AND” instruction is decoded, turning on a “write_AND” data switch of the complementary data switches in the memory cell corresponding to the address instruction, wherein the data written from the data transmission line can switch the non-inverted data in the cross-coupled inverters from 1 to 0, but not from 0 to 1; if a write instruction is decoded, turning on both of the complementary data switches in the memory cell corresponding to the address instruction, wherein the data written from the data transmission line can switch the data in the cross-coupled inverters in a bidirectional manner.

The memory cell may comprise SRAM cell, DRAM cell or FLASH cell.

A first memory with an accumulated write feature comprises an interface unit, an instruction/address decoder, a plurality of memory cells, and data transmission lines comprising a non-inverted data transmission line and an inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively; the memory is characterized by: the interface unit comprises a write arithmetic instruction interface, a write instruction interface, and an address instruction interface; the write arithmetic instruction interface comprises a “write_OR” instruction interface and/or a “write_AND” instruction interface; the instruction/address decoder is configured to decode a write arithmetic instruction, a write instruction and an address instruction; the pFET has a higher driving capability than the data switches, and the nFET has a lower driving capability than the data switches.

The memory cell may comprise SRAM cell, DRAM cell or FLASH cell.

A second memory with an accumulated write feature comprises an interface unit, an instruction/address decoder, a plurality of memory cells, and data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively; the memory is characterized by: the interface unit comprises a write arithmetic instruction interface, a write instruction interface, and an address instruction interface; the write arithmetic instruction interface comprises a “write_OR” instruction interface and/or a “write_AND” instruction interface; the instruction/address decoder is configured to decode a write arithmetic instruction, a write instruction and an address instruction; the pFET has a lower driving capability than the data switches, and the nFET has a higher driving capability than the data switches.

The memory cell may comprise SRAM cell, DRAM cell or FLASH cell.

A first storage system with an accumulated write feature comprises a memory controller or CPU, an instruction/address decoder, data transmission lines, a plurality of caches and a plurality of memory cells, the data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively; the storage system is characterized by: the controller is configured to issue a write arithmetic instruction, a write instruction and an address instruction to the instruction/address decoder; the write arithmetic instruction comprises a “write_OR” instruction and/or a “write_AND” instruction; the instruction/address decoder is configured to decode a write arithmetic instruction, a write instruction and an address instruction; the pFET has a higher driving capability than the data switches, and the nFET has a lower driving capability than the data switches.

The memory cell may comprise SRAM cell, DRAM cell or FLASH cell.

A second storage system with an accumulated write feature comprises a memory controller or CPU, an instruction/address decoder, data transmission lines, a plurality of caches and a plurality of memory cells, the data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively; the storage system is characterized by: the controller is configured to issue a write arithmetic instruction, a write instruction and an address instruction to the instruction/address decoder; the write arithmetic instruction comprises a “write_OR” instruction and/or a “write_AND” instruction; the instruction/address decoder is configured to decode a write arithmetic instruction, a write instruction and an address instruction; the pFET has a lower driving capability than the data switches, and the nFET has a higher driving capability than the data switches.

The memory cell may comprise SRAM cell, DRAM cell or FLASH cell.

The present invention has the following advantages:

a) the present invention can reduce the work load of CPU/ALU;
b) the present invention can continuously write data to the memory (without first reading data); that is, there is no need for execution of the cycle of read-wait-write-wait, and only a write instruction is executed; in this way, it is now sufficient to access the memory only once, other than twice in the conventional technology;
c) the present invention can avoid delay caused by the switching since only the write instructions needs to be executed, and can be executed in a continuous manner.

### BRIEF DESCRIPTION OF THE DRAWINGS

FIG. 1 is a typical circuit diagram of a conventional SRAM;

FIG. 2 is a circuit diagram showing a SRAM that can execute a “write_OR” instruction according to the present invention;

FIG. 3 is another circuit diagram showing a SRAM that can execute a “write_OR” instruction according to the present invention;

FIG. 4 is a circuit diagram showing a SRAM that can execute a “write_AND” instruction according to the present invention;

FIG. 5 is another circuit diagram showing a SRAM that can execute a “write_AND” instruction according to the present invention;

FIG. 6 is a circuit diagram showing a SRAM that can execute “write_OR” and “write_AND” instructions according to the present invention;

FIG. 7 is another circuit diagram showing a SRAM that can execute “write_OR” and “write_AND” instructions according to the present invention;

FIG. 8 is a typical circuit diagram of a conventional DRAM;

FIG. 9 is a circuit diagram showing a DRAM that can execute a “write_OR” instruction according to the present invention;

FIG. 10 is another circuit diagram showing a DRAM that can execute a “write_OR” instruction according to the present invention;

FIG. 11 is a circuit diagram showing a DRAM that can execute a “write_AND” instruction according to the present invention;

FIG. 12 is another circuit diagram showing a DRAM that can execute a “write_AND” instruction according to the present invention;

FIG. 13 is a circuit diagram showing a DRAM that can execute “write_OR” and “write_AND” instructions according to the present invention;

FIG. 14 is another circuit diagram showing a DRAM that can execute “write_OR” and “write_AND” instructions according to the present invention.

### DETAILED DESCRIPTION

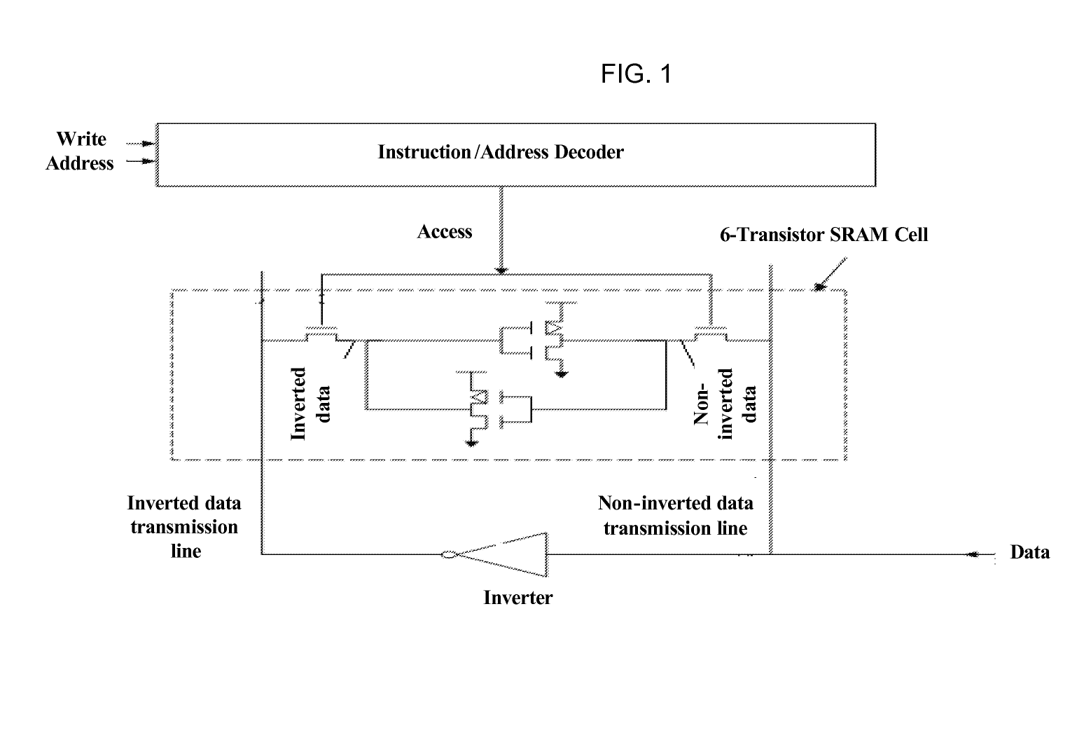

FIG. 1 shows a typical 6-transistor SRAM cell having two cross-coupled inverters (NOT gate) and two data switches (transistors). With the data switches, the cell can couple non-inverted and inverted data to non-inverted and inverted data transmission lines, respectively (only write path is shown).

Access lines will activate a SRAM cell matched with an address if a general write instruction is issued. Data will be transferred via the data switches from the data transmission lines (which are shared by a plurality of cells, and only one cell is shown) to the cross-coupled inverters. Then, information previously stored in the SRAM cell will be covered and rewritten.

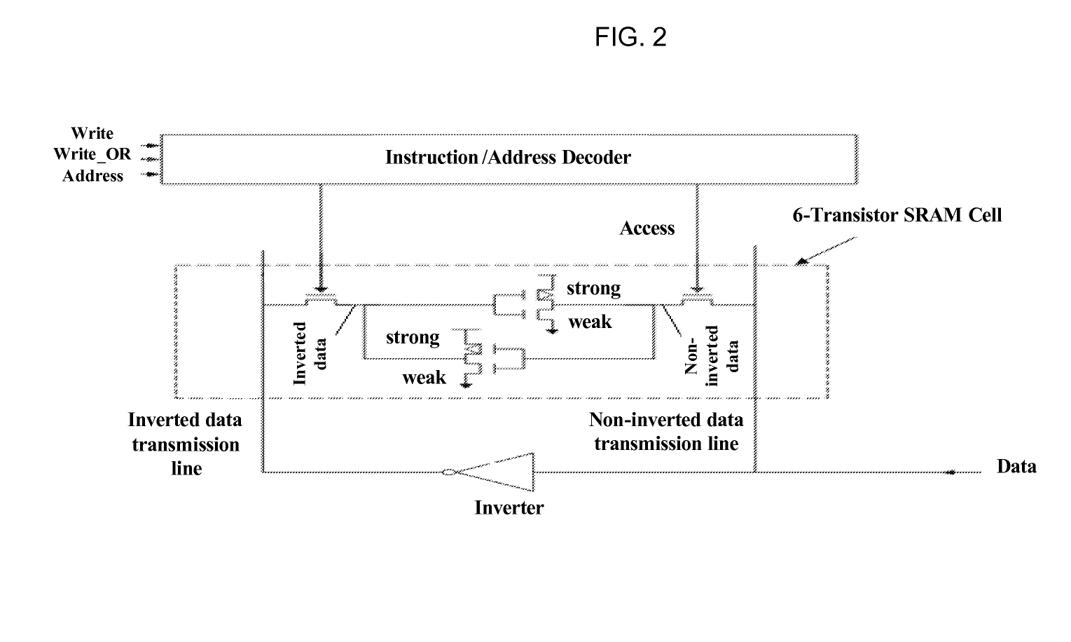

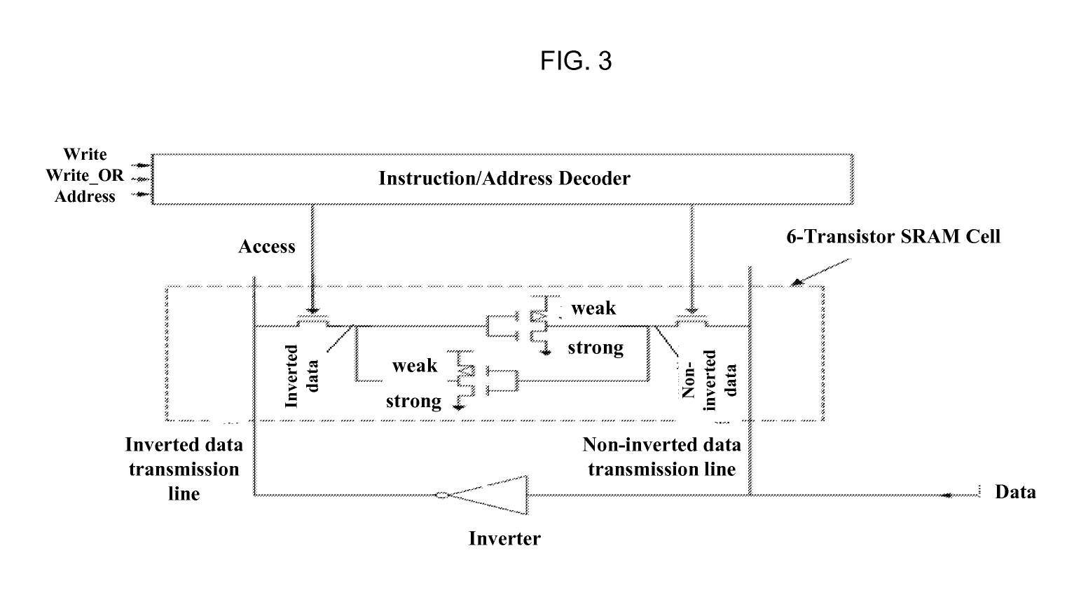

FIGS. 2 and 3 show circuit arrangements of SRAM cells that can execute a “write_OR” instruction according to the present invention. The modified instruction decoder can decode a “write_OR” instruction concurrently with decoding of a write instruction. The write function is not changed with respect to the circuit arrangement of FIG. 1. The circuit of the present invention is different in that the access lines are separated. When a “write_OR” instruction is detected, and the address is matched, only one access line (i.e., the single access line on the right side of FIG. 2 or the single access line on the left side of FIG. 3) is activated. The transistors within a SRAM cell are classified in terms of size. In the cross-coupled inverters of FIG. 2, the p-type field effect transistors (pFETs) are made stronger (compared with the data switches), and the n-type field effect transistors (nFETs) are make weaker (also compared with the data switches). In the cross-coupled inverters of FIG. 3, the pFETs are made weaker (compared with the data switches), and the nFETs are make stronger (also compared with the data switches). Whether a transistor is strong or weak can be determined as: for a strong transistor, a single data switch cannot drive the strong transistor, and cannot rewrite data in the memory cell; and for a weak transistor, a single data switch can drive the weak transistor, and can rewrite data in the memory cell.

In FIG. 2, if a write instruction writes non-inverted data 0 into the cross-coupled inverters (0 is present on the non-inverted data transmission line, while 1 is present on the inverted data transmission line), the weak nFETs will hold the non-inverted data. At this time, if a “write_OR” instruction is to write non-inverted data 1 (1 is present on the non-inverted data transmission line, while 0 is present on the inverted data transmission line), the non-inverted data transmission line will drive the weak nFETs via the data switches, and thus cover the non-inverted data 0, and rewrite the non-inverted data in the cross-coupled inverters (the inverted data are also changed simultaneously).

If the non-inverted data 1 has been stored in the cross-coupled inverters, the strong pFETs will maintain the non-inverted data. At this time, if a “write_OR” instruction is to write non-inverted data 0 (0 is present on the non-inverted data transmission line, while 1 is present on the inverted data transmission line), the data 0 on the non-inverted data transmission line will drive the strong pFETs via the data switches, but will not rewrite the non-inverted data in the cross-coupled inverters. As a result, the non-inverted data 1 remains as stored in the cross-coupled inverters.

In FIG. 3, if a write instruction writes inverted data 1 into the cross-coupled inverters (0 is present on the non-inverted data transmission line, while 1 is present on the inverted data transmission line), the weak pFETs will hold the inverted data. At this time, if a “write_OR” instruction is to write inverted data 0 (1 is present on the non-inverted data transmission line, while 0 is present on the inverted data transmission line), the inverted data transmission line will drive the weak pFETs via the data switches, and thus cover the inverted data 0, and rewrite the inverted data in the cross-coupled inverters (the non-inverted data are also changed simultaneously).

If the non-inverted data 1 has been stored in the cross-coupled inverters, the strong nFETs will maintain the inverted data 0 (and the non-inverted data 1). At this time, if a “write_OR” instruction is to write inverted data 1 (0 is present on the non-inverted data transmission line, while 1 is present on the inverted data transmission line), the data 1 on the inverted data transmission line will drive the strong nFETs via the data switches, but will not rewrite the inverted data in the cross-coupled inverters. As a result, the inverted data 0 remains as stored in the cross-coupled inverters (the non-inverted data 1 also remains as stored in the other side of the cross-coupled inverters).

Accordingly, 1 (non-inverted data) will be accumulated (or operated) in the inverters. Once 1 (non-inverted data) has been stored in the cross-coupled inverters, the 1 (non-inverted data) will be stored persistently if only the “write_OR” operation is performed.

If a general write instruction occurs, both of the data switches will be turned on, and data of two polarities can be stored. In FIG. 2, the cross-coupled inverters have one side at the 0 level that is held by the weak nFETs. The status of the weak nFETs can be changed by writing 1 through the non-inverted or inverted data transmission line, and thus the data in the memory cell can be rewritten. In FIG. 3, the cross-coupled inverters have one side at the 1 level that is held by the weak pFETs. The status of the weak pFETs can be changed by writing 0 through the non-inverted or inverted data transmission line, and thus the data in the memory cell can be rewritten.

In this way, it is possible to unconditionally write data of both polarities.

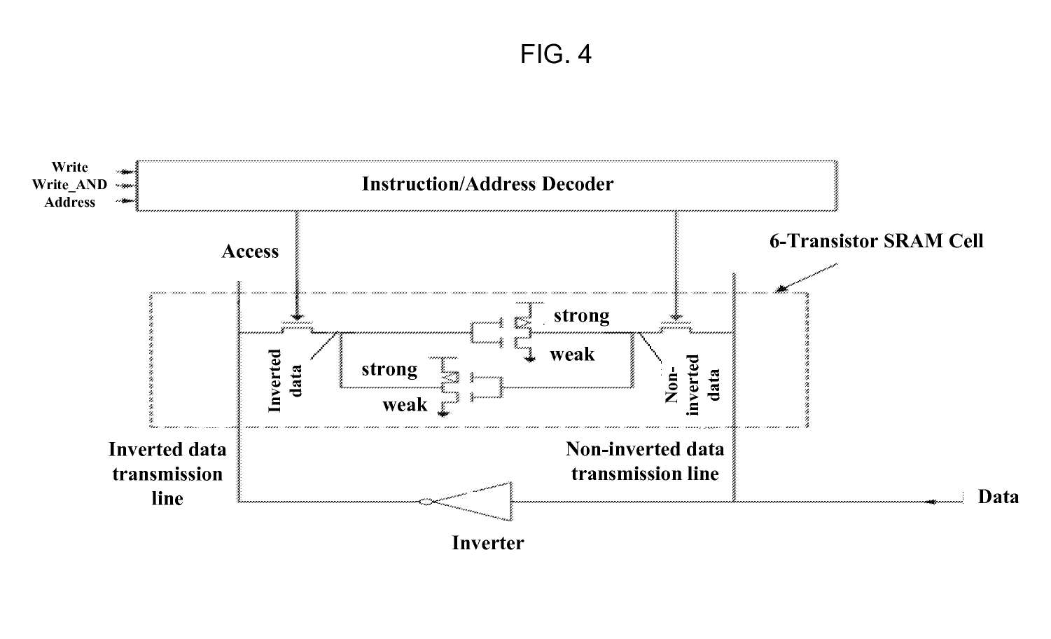

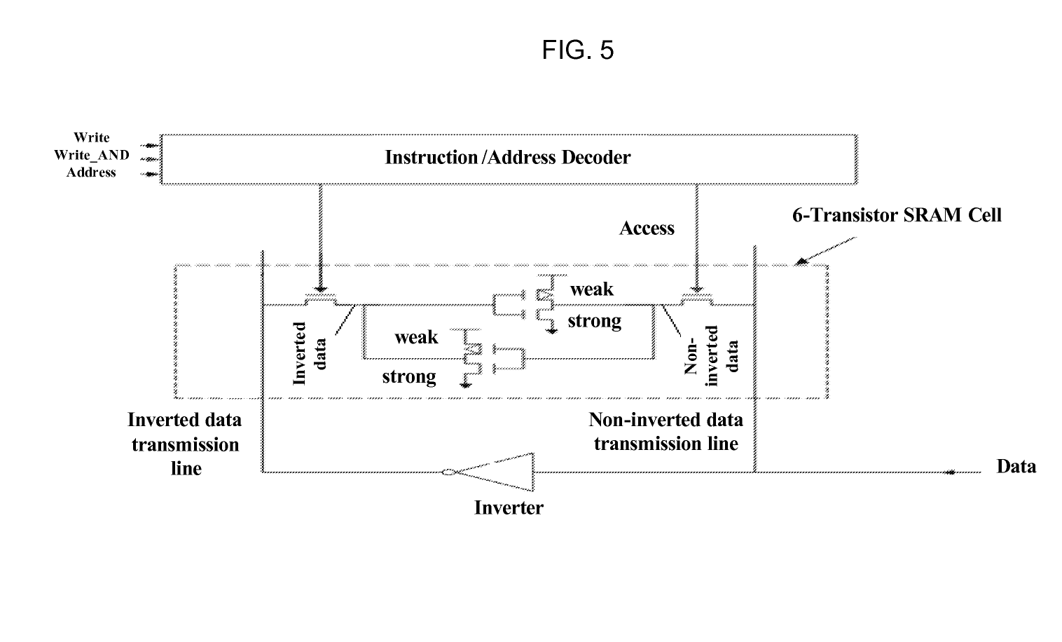

FIGS. 4 and 5 show circuit arrangements of SRAM cells that can execute a “write_AND” instruction according to the present invention. Unlike the circuits shown in FIGS. 2 and 3, when a “write_AND” instruction is detected, and the address is matched, only one access line, i.e., the single access line on the left side of FIG. 4 or the single access line on the right side of FIG. 5, is activated. In the cross-coupled inverters of FIG. 4, the p-type field effect transistors (pFETs) are made stronger (compared with the data switches), and the n-type field effect transistors (nFETs) are make weaker (also compared with the data switches). In the cross-coupled inverters of FIG. 5, the pFETs are made weaker (compared with the data switches), and the nFETs are make stronger (also compared with the data switches).

In FIG. 4, if a write instruction writes inverted data 0 into the cross-coupled inverters (1 is present on the non-inverted data transmission line, while 0 is present on the inverted data transmission line), the weak nFETs will hold the inverted data. At this time, if a “write_AND” instruction is to write inverted data 1 (0 is present on the non-inverted data transmission line, while 1 is present on the inverted data transmission line), the inverted data transmission line will drive the weak nFETs via the data switches, and thus cover the inverted data 0, and rewrite the inverted data in the cross-coupled inverters (the non-inverted data are also changed simultaneously).

If the non-inverted data 0 has been stored in the cross-coupled inverters, the strong pFETs will maintain the non-inverted data. At this time, if a “write_AND” instruction is to write inverted data 0 (1 is present on the non-inverted data transmission line, while 0 is present on the inverted data transmission line), the data 0 on the inverted data transmission line will drive the strong pFETs via the data switches, but will not rewrite the inverted data in the cross-coupled inverters. As a result, the inverted data 1 remains as stored in the cross-coupled inverters (the non-inverted data 0 also remains as stored in the cross-coupled inverters).

In FIG. 5, if a write instruction writes non-inverted data 1 into the cross-coupled inverters (1 is present on the non-inverted data transmission line, while 0 is present on the inverted data transmission line), the weak pFETs will hold the non-inverted data. At this time, if a “write_AND” instruction is to write non-inverted data 0 (0 is present on the non-inverted data transmission line, while 1 is present on the inverted data transmission line), the non-inverted data transmission line will drive the weak pFETs via the data switches, and thus cover the non-inverted data 0, and rewrite the non-inverted data in the cross-coupled inverters (the inverted data are also changed simultaneously).

If the non-inverted data 0 has been stored in the cross-coupled inverters, the strong nFETs will maintain the non-inverted data. At this time, if a “write_AND” instruction is to write non-inverted data 1 (1 is present on the non-inverted data transmission line, while 0 is present on the inverted data transmission line), the data 1 on the non-inverted data transmission line will drive the strong nFETs via the data switches, but will not rewrite the non-inverted data in the cross-coupled inverters. As a result, the non-inverted data 0 remains as stored in the cross-coupled inverters (the inverted data 1 also remains as stored in the cross-coupled inverters).

Accordingly, 0 (non-inverted data) will be accumulated (or operated) in the inverters. Once 0 (non-inverted data) has been stored in the cross-coupled inverters, the 0 (non-inverted data) will be stored persistently if only the “write_AND” operation is performed.

If a general write instruction occurs, both of the data switches will be turned on, and data of two polarities can be stored. In FIG. 4, the cross-coupled inverters have one side at the 0 level that is held by the weak nFETs. The status of the weak nFETs can be changed by writing 1 through the non-inverted or inverted data transmission line, and thus the data in the memory cell can be rewritten. In FIG. 5, the cross-coupled inverters have one side at the 1 level that is held by the weak pFETs. The status of the weak pFETs can be changed by writing 0 through the non-inverted or inverted data transmission line, and thus the data in the memory cell can be rewritten.

In this way, it is possible to unconditionally write data of both polarities.

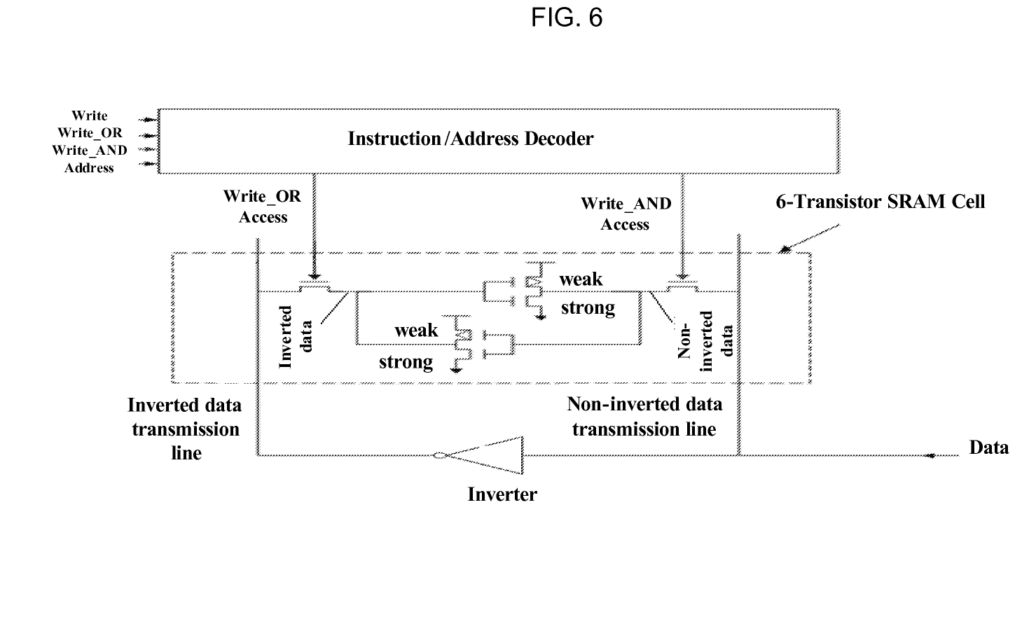

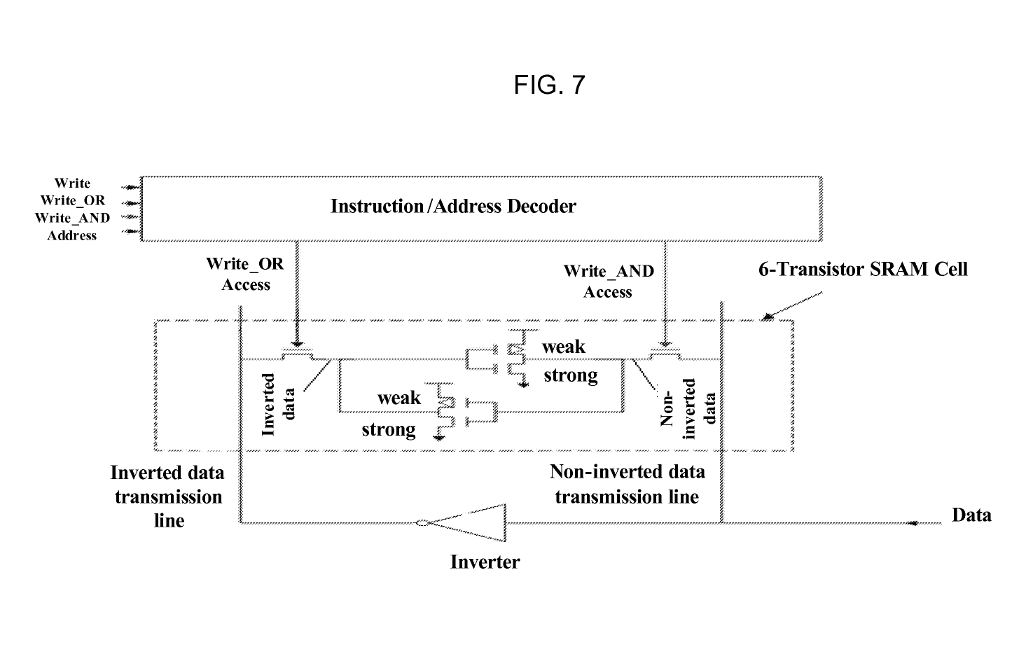

With reference to FIGS. 6 and 7, since whether the pFETs and the nFETs are strong or weak has been defined for a particular SRAM cell, one of the access lines will be activated if a “write_OR” operation is performed, while the other access line will be activated if a “write_AND” operation is performed. In other words, the “write_OR” and “write_AND” operations can be performed concurrently in the same memory.

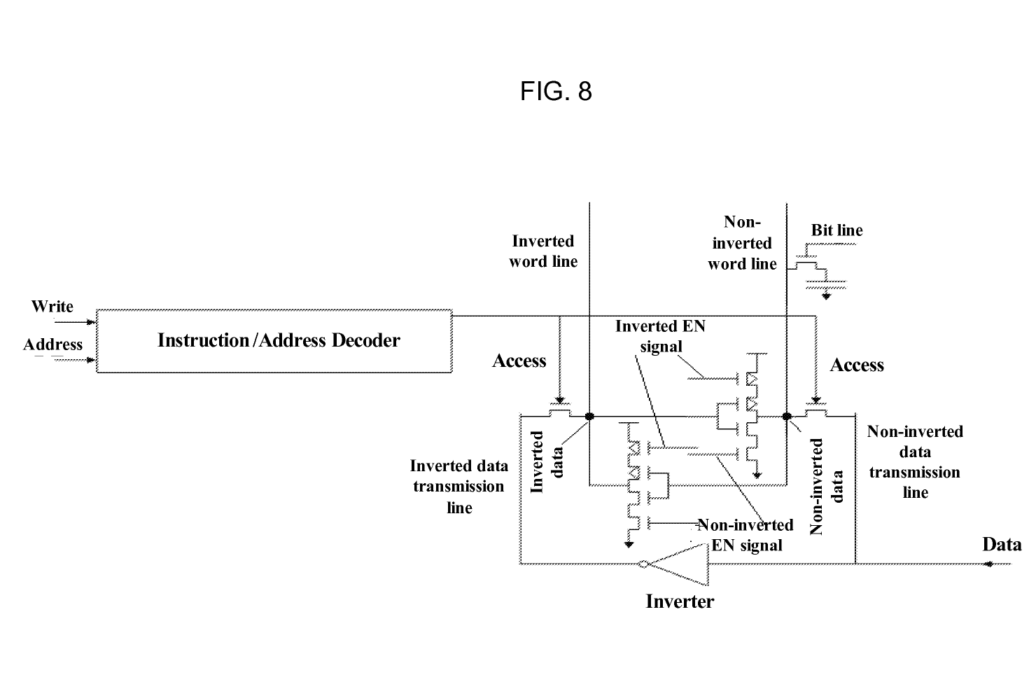

FIG. 8 shows the circuit arrangement of a conventional DRAM. SRAM differs from DRAM in that SRAM is able to maintain data stored in the inverters. DRAM can store data in capacitors, and amplify readout data by a sensing amplifier through comparison with a reference voltage. The foregoing typical 6-transistor SRAM cell may be used as the sensing amplifier of DRAM (under the control of non-inverted and inverted enable signals). An additional transistor controlled by word lines is required to connect a single memory cell (or a plurality of parallel-coupled cells controlled by different word lines) to the sensing amplifier. To be noted, the typical 6-transistor SRAM cell may be used as a primary or secondary sensing amplifier. The primary or secondary sensing amplifier may be located at any part of an internal path from a receiver to a memory cell within the memory.

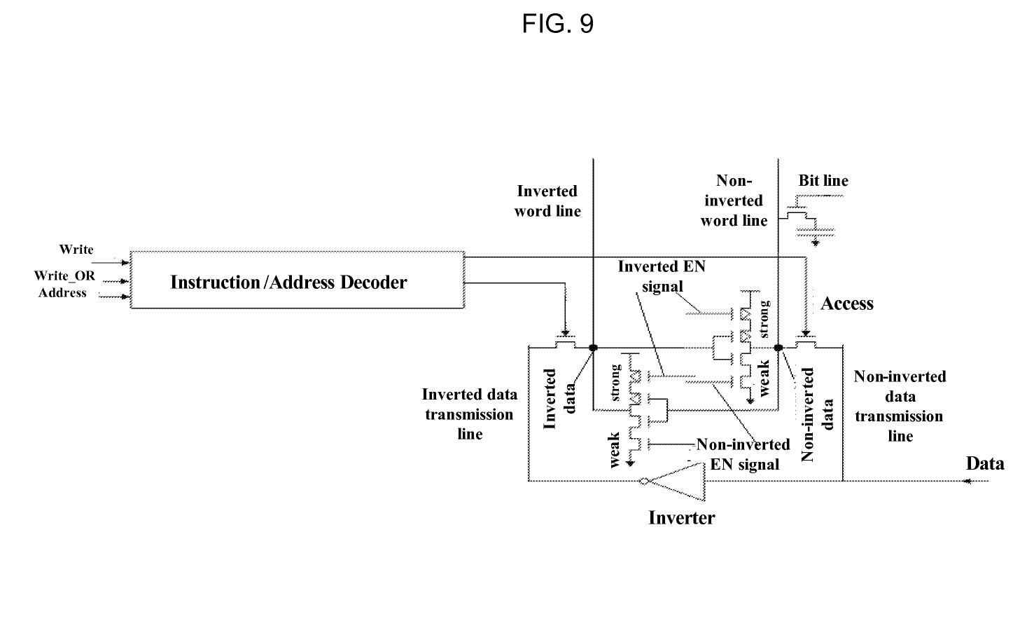

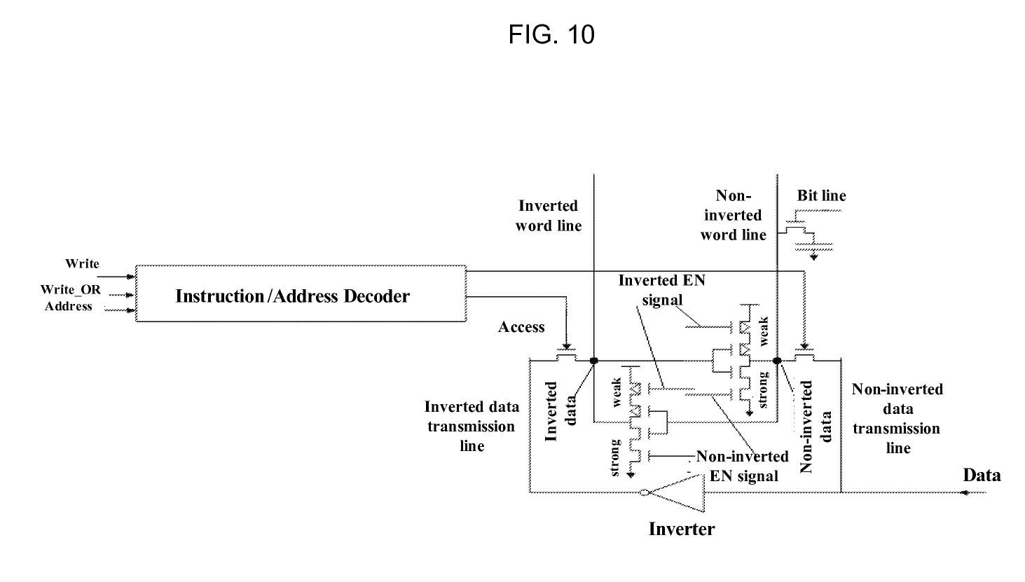

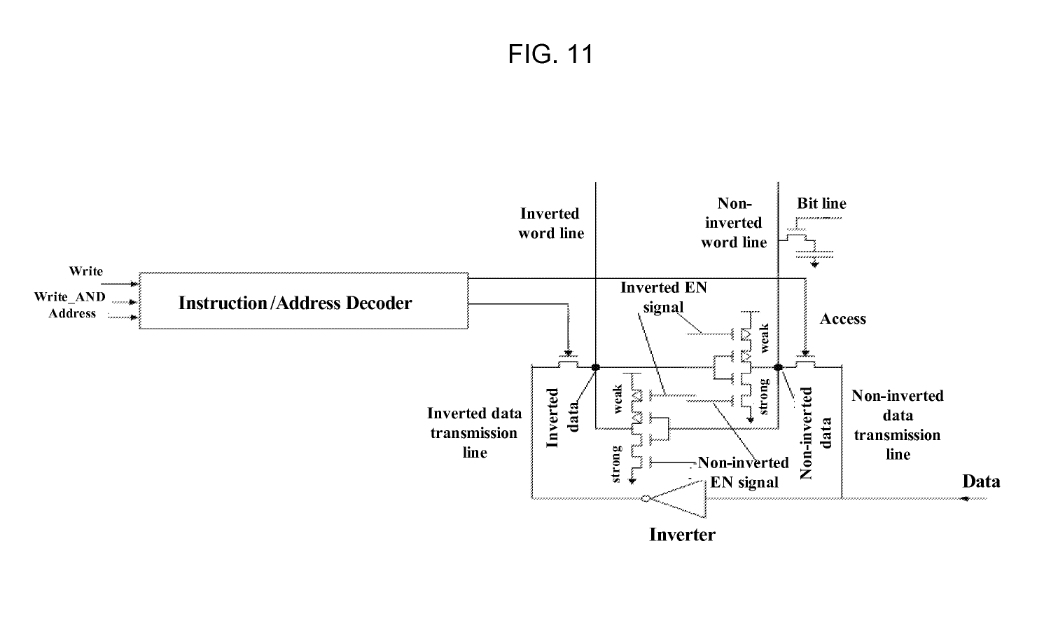

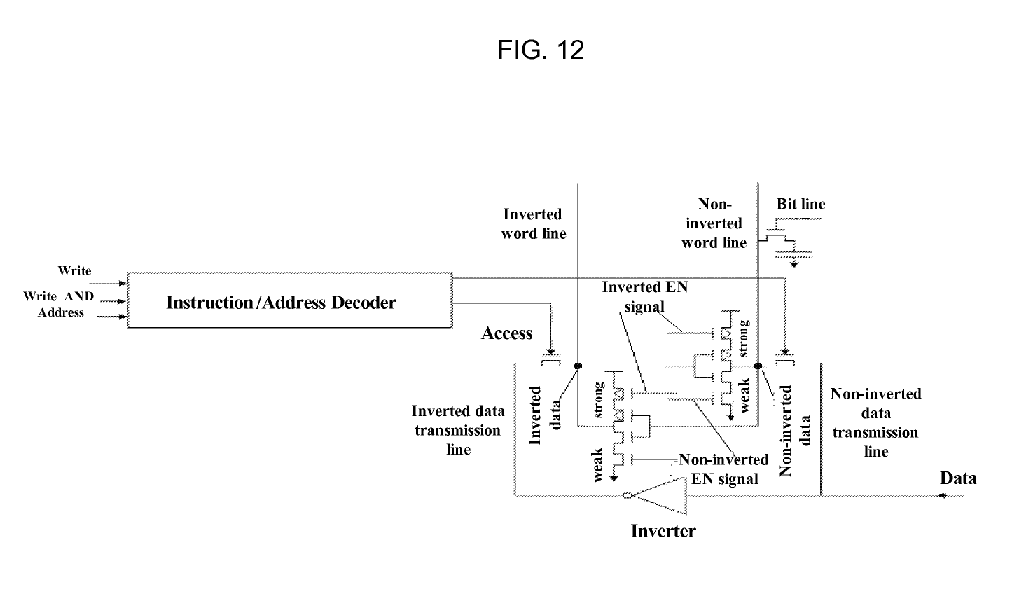

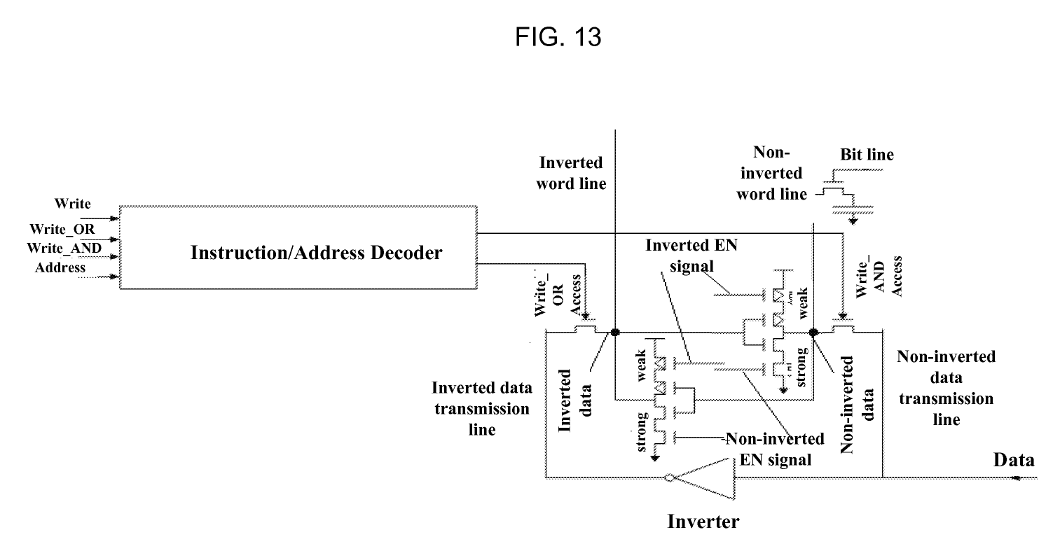

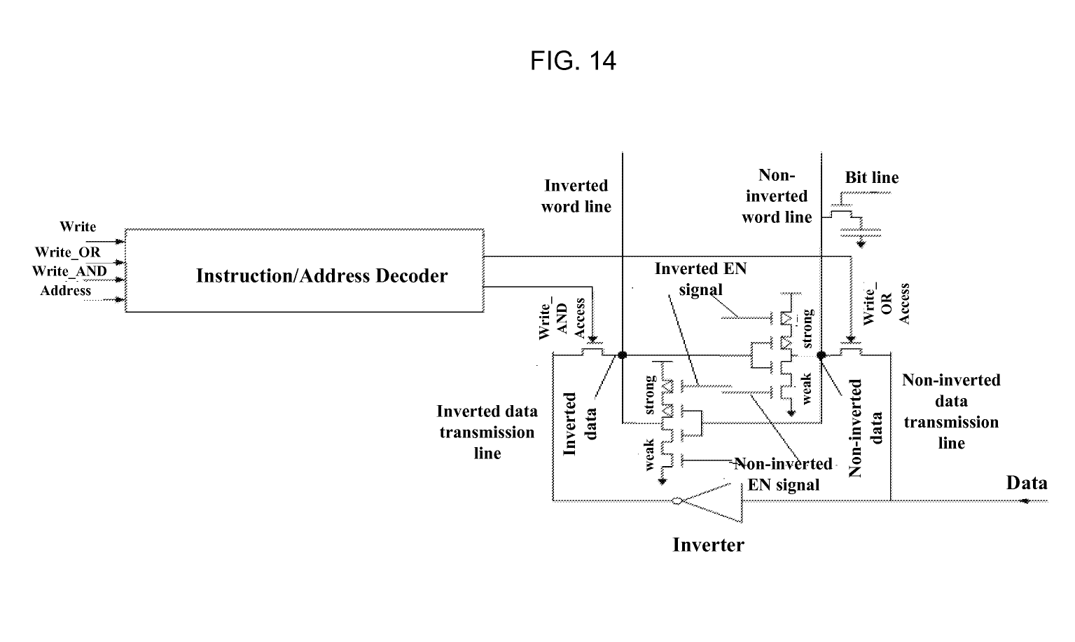

FIGS. 9 and 10 show two circuit arrangements of a DRAM cell that can execute a “write_OR” instruction according to the present invention. FIGS. 11 and 12 show two circuit arrangements of a DRAM cell that can execute a “write_AND” instruction according to the present invention. FIGS. 13 and 14 show two circuit arrangements of a DRAM cell that can execute “write_OR” and “write_AND” instructions according to the present invention. These circuits can be implemented in the same principle as the implementations of SRAM.

The present invention can be applied in a FLASH cell similarly to application in the DRAM cell.

According to the prevention invention, the principle for executing a “write_OR” instruction in a SRAM, DRAM or FLASH cell is as follows:

1) a standard instruction interface is added between the memory controller/CPU and the memory, so that a “write_OR” instruction can be issued;
2) one instruction/address decoder in the memory can be used to decode the “write_OR” instruction;
3) only one of the complementary data switches (or complementary data switch circuits) is turned on when the “write_OR” instruction is decoded;
4) the cross-coupled inverters can switch the non-inverted data from 0 to 1, but not from 1 to 0, when only one of the data switches is turned on; data can be written in a bidirectional manner when both of the data switches are in an enabled status.

According to the prevention invention, the principle for executing a “write_AND” instruction in a SRAM, DRAM or FLASH cell is as follows:

1) a standard instruction interface is added between the memory controller/CPU and the memory, so that a “write_AND” instruction can be issued;
2) one instruction/address decoder in the memory can be used to decode the “write_AND” instruction;
3) only one of the complementary data switches (or complementary data switch circuits) is turned on when the “write_AND” instruction is decoded;
4) the cross-coupled inverters can switch the non-inverted data from 1 to 0, but not from 0 to 1, when only one of the data switches is turned on; data can be written in a bidirectional manner when both of the data switches are in an enabled status.

The present invention can be also applied in a storage system with an accumulated write feature. The system can perform a “write_OR” or “write_AND” operation in the memory or the cache. The system includes a controller or CPU, a plurality of caches, an instruction/address decoder, data transmission lines, and a plurality of memory cells. The data transmission lines include a non-inverted data transmission line and a inverted data transmission line. Each of the memory cell includes two complementary data switches and two cross-coupled inverters. Each of the inverters comprises a p-type field effect transistor (pFET) and a n-type FET (nFET). The instruction/address decoder has output terminals coupled to the two complementary data switches, respectively. The controller is configured to issue a write arithmetic instruction, a write instruction and an address instruction to the instruction/address decoder. The instruction/address decoder is configured to decode a write arithmetic instruction, a write instruction and an address instruction. The write arithmetic instruction instructs a “write_OR” or “write_AND” operation. One of the pFET or the nFET of the cross-coupled inverters must have a higher driving capability than the data switches, and the other one must have a lower driving capability than the data switches.

What is claimed is:

1. A storage method with an accumulated write feature, comprising steps of:
1) providing a standard instruction interface between a controller or CPU and a memory, so that the controller or CPU can send a write instruction, an address instruction and a write arithmetic instruction to the memory, wherein the write arithmetic instruction comprises a “write_OR” instruction and/or a “write_AND” instruction;
2) decoding the write instruction, the address instruction and the write arithmetic instruction by an instruction/address decoder in the memory;
3) if a “write_OR” instruction is decoded, turning on a “write_OR” data switch of complementary data switches in a memory cell corresponding to the address instruction, wherein data written from a data transmission line can switch non-inverted data in cross-coupled inverters from 0 to 1, but not from 1 to 0; if a “write_AND” instruction is decoded, turning on a “write_AND” data switch of the complementary data switches in the memory cell corresponding to the address instruction, wherein the data written from the data transmission line can switch the non-inverted data in the cross-coupled inverters from 1 to 0, but not from 0 to 1; if a write instruction is decoded, turning on both of the complementary data switches in the memory cell corresponding to the address instruction, wherein the data written from the data transmission line can switch the data in the cross-coupled inverters in a bidirectional manner.

2. The storage method with an accumulated write feature of claim 1, wherein the memory cell comprises a SRAM cell, a DRAM cell or a FLASH cell.

3. A memory with an accumulated write feature, comprising an interface unit, an instruction/address decoder, a plurality of memory cells, and data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively;
characterized by:
the interface unit comprises a write arithmetic instruction interface, a write instruction interface, and an address instruction interface; the write arithmetic instruction interface comprises a “write_OR” instruction interface and/or a “write_AND” instruction interface; the instruction/address decoder is configured to decode a write arithmetic instruction, a write instruction and an address instruction; and
the pFET has a higher driving capability than the data switches, and the nFET has a lower driving capability than the data switches.

4. The memory with an accumulated write feature of claim 3, wherein the memory cell comprises a SRAM cell, a DRAM cell or a FLASH cell.

5. A memory with an accumulated write feature, comprising an interface unit, an instruction/address decoder, a plurality of memory cells, and data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively;
characterized by:
the interface unit comprises a write arithmetic instruction interface, a write instruction interface, and an address instruction interface; the write arithmetic instruction interface comprises a “write_OR” instruction interface and/or a “write_AND” instruction interface; the instruction/address decoder is configured to decode a write arithmetic instruction, a write instruction and an address instruction; and
the pFET has a lower driving capability than the data switches, and the nFET has a higher driving capability than the data switches.

6. The memory with an accumulated write feature of claim 5, wherein the memory cell comprises a SRAM cell, a DRAM cell or a FLASH cell.

7. A storage system with an accumulated write feature, comprising a memory controller or CPU, an instruction/address decoder, data transmission lines, a plurality of caches and a plurality of memory cells, the data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively;
characterized by:
the controller is configured to issue a write arithmetic instruction, a write instruction and an address instruction to the instruction/address decoder; the write arithmetic instruction comprises a “write_OR” instruction and/or a “write_AND” instruction;
the instruction/address decoder is configured to decode a write arithmetic instruction, a write instruction and an address instruction; and
the pFET has a higher driving capability than the data switches, and the nFET has a lower driving capability than the data switches.

8. The storage system with an accumulated write feature of claim 7, wherein the memory cell comprises a SRAM cell, a DRAM cell or a FLASH cell.

9. A storage system with an accumulated write feature, comprising a memory controller or CPU, an instruction/address decoder, data transmission lines, a plurality of caches and a plurality of memory cells, the data transmission lines comprising a non-inverted data transmission line and a inverted data transmission line, each of the memory cell comprises two complementary data switches and two cross-coupled inverters; each of the inverters comprises a p-type field effect transistor (pFET) and a n-type FET (nFET); the instruction/address decoder has output terminals coupled to the two complementary data switches, respectively; the two complementary data switches are coupled to the non-inverted data transmission line and the non-inverted data, and to the inverted data transmission line and the inverted data, respectively;
characterized by:
the controller is configured to issue a write arithmetic instruction, a write instruction and an address instruction to the instruction/address decoder; the write arithmetic instruction comprises a “write_OR” instruction and/or a “write_AND” instruction;
the instruction/address decoder is configured to decode a write arithmetic instruction, a write instruction and an address instruction; and
the pFET has a lower driving capability than the data switches, and the nFET has a higher driving capability than the data switches.

10. The storage system with an accumulated write feature of claim 9, wherein the memory cell comprises a SRAM cell, a DRAM cell or a FLASH cell.
